(19) United States
(12) Patent Application Publication
(10) Pub. No.: US 2021/0337964 A1
(43) Pub. Date: Nov. 4, 2021

(54) STACKING BRACKET FOR STORAGE RACK

(71) Applicant: JS Products, Inc., Las Vegas, NV (US)

(72) Inventors: Dylan Williams, Las Vegas, NV (US); Glen David Richardson, Las Vegas, NV (US)

(21) Appl. No.: 17/245,661

(22) Filed: Apr. 30, 2021

Related U.S. Application Data
(60) Provisional application No. 62/704,259, filed on Apr. 30, 2020.

(51) Int. Cl. A47B 57/48; A47B 57/34

(52) U.S. Cl. CPC A47B 57/482; A47B 57/34

(57) ABSTRACT

A stacking bracket with locking tabs for easily, economically, and securely attaching and horizontal shelving to an upright shelving support post rack assembly as well as connecting and stacking such rack assemblies vertically together, the system and component parts being adaptable and configurable such that shelves, drawers, and other rack accessory elements may be readily incorporated into the system, assembly, and methods for use of same.

### CROSS-REFERENCE TO RELATED APPLICATION

This application claims priority to U.S. Provisional Application No. 62/704,259 which was filed on Apr. 30, 2021, the contents of which are hereby incorporated by reference.

### FIELD OF THE INVENTION

The present invention relates to an instrument of particular utility for effective and secure stacking of storage rack units.

### BACKGROUND OF THE INVENTION

Simple and cost-effective means for securing the structure and stacking of storage rack units in a storage shelving assembly has long been an interest and concern in the shipping and warehousing industries. The present invention provides an elegant and readily mass-produced bracket instrument and system to easily and economically implement a new solution to strengthen and secure rack systems for home, garage, and warehouse use.

### SUMMARY OF THE INVENTION

An objective of the present invention is to provide a simple tool comprising a bracket configured in such manner, with a protruding tab that inserts into receiver apertures in the shelving upright support post structures, to easily attach and secure the bracket to the upright and, additionally, to provide a horizontal support for horizontal load-bearing shelving to be placed, and stacked, in connection with the bracket upon the upright shelving rack structure.

### DESCRIPTION OF THE DRAWINGS

FIG. 1 provides perspective views of the stacking brackets in both left-stacking and right-stacking configurations.

FIG. 2 is a perspective view of stacking brackets as attached to an upright shelving support beam structure.

FIG. 3 is a perspective view of a complete shelving assembly incorporating stacking brackets to securely attach multiple horizontal shelves to a rack assembly of upright load-bearing support beam structures.

FIG. 4 is a perspective view of stacking brackets as attached to an upright shelving support post structure wherein additional diagonal and horizontal cross beam support structures and retractable drawer structure are also fixed to the upright support post.

FIG. 5 is a perspective view of a mounted stacking bracket-type accessory that provides as an attachment both horizontal crossbeam and a diagonal crossbeam structural support arms that span across and join one upright vertical support post or beam to another upright vertical support post or beam in the overall rack assembly structure.

### DETAILED DESCRIPTION OF EMBODIMENTS

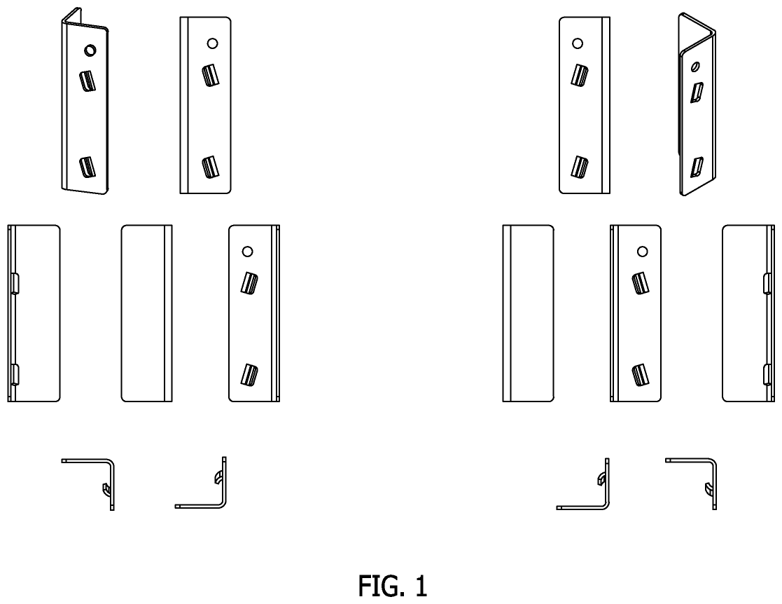

Brackets and methods for stacking a storage rack are described herein. The brackets are configured to securely connect a first storage rack unit on top of a second storage rack unit. FIG. 1 shows several views of both a left stacking bracket and a right stacking bracket. Both the left and right stacking brackets are preferably formed from a metallic material such as steel, aluminum, various alloys thereof, or any other suitable material known in the art.

The left and right stacking brackets are formed with a substantially L-shaped cross section where a first extension is substantially perpendicular to a second extension. The two extensions are joined at a corner. In this embodiment, the corner is rounded, but the corner may also be at a sharp angle.

On one of the extensions, the bracket comprises one or more tabs. The tabs may be formed via a punching operation in the sheet metal such that the tabs protrude (internally within the extension corner angle) from an aperture in the extension of the bracket. The tabs may be formed at a diagonal angle relative and away from the side edges of the bracket.

The extension also comprises a locking pin aperture. As shown in FIG. 1, the locking pin aperture may be disposed above the tabs. The locking pin aperture is configured to receive a locking pin that locks the bracket in place on an upright of a storage rack.

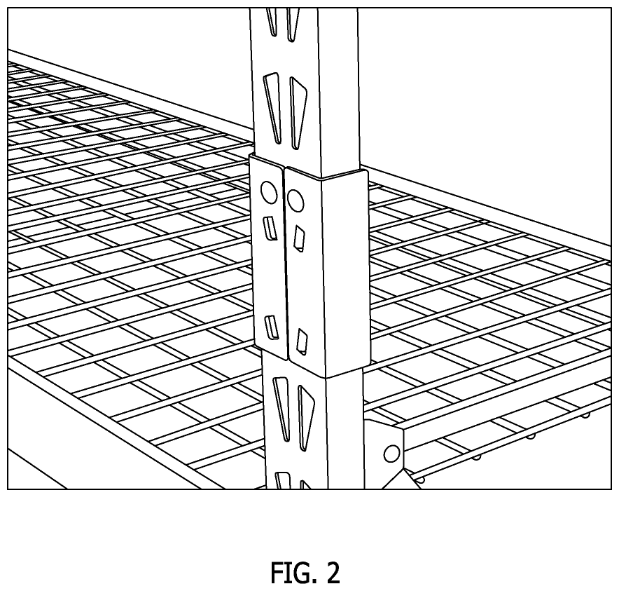

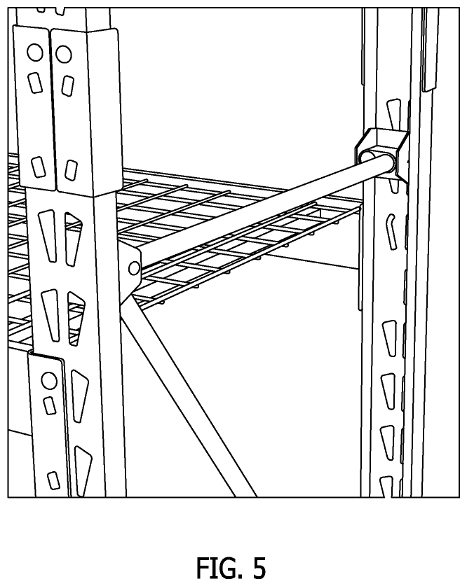

FIGS. 2 and 5 show a close-up view of a left- and right-side stacking bracket installed on the outer side of adjacent uprights of a storage rack. As shown in FIGS. 2 and 5, the tabs on the left- and right-side stacking brackets are inserted into attachment holes on the upright. In a preferred embodiment, the lower tab of the stacking bracket is attached to an attachment receiver open hole aperture of the lower upright, and the upper tab of the stacking bracket is attached to an attachment receiver open aperture hole of the upper upright. In this fashion, as each stacking bracket securely connects separate upper and lower rack upright posts, the stacking brackets may thus be used to securely connect and stack rack assembly units vertically in succession.

The attachment holes are wider towards a top side of the receiver attachment open aperture holes and narrower towards the bottom. This allows the tabs of the stacking brackets to be inserted towards the top of the receiver attachment open aperture holes. When the tabs slide or otherwise move downward in the holes, the tabs move to a locking position where they cannot be removed from the receiver attachment open aperture holes.

To ensure that the stacking brackets do not accidently move upwards into a position where they can be removed, a locking pin is provided that extends through the locking pin aperture of the stacking bracket and through the wider top side of the receiver attachment open aperture holes. This locks the stacking bracket in place because the tabs may not move out of engagement with the receiver attachment open aperture holes.

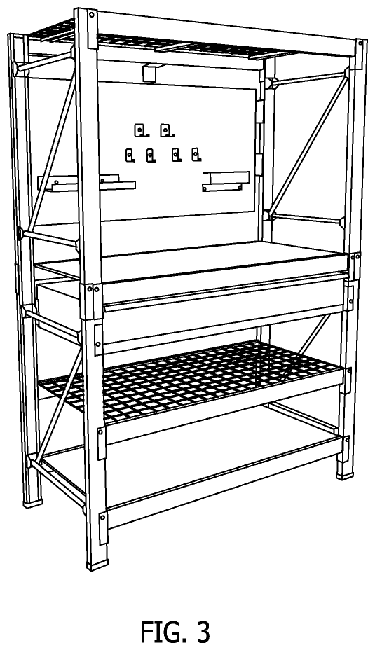

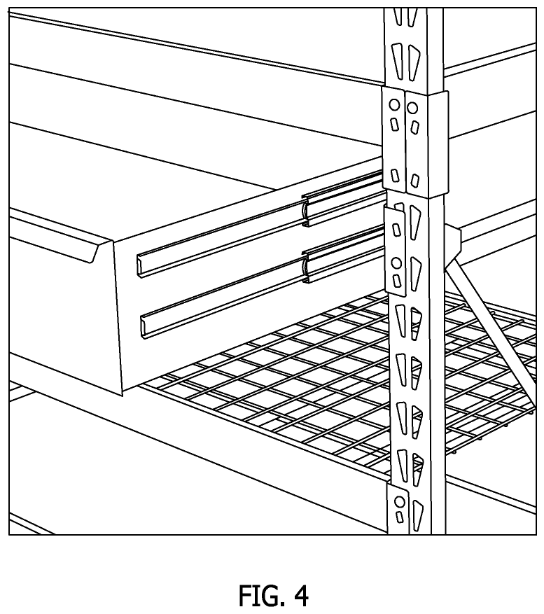

FIGS. 3 and 4 show the stacking brackets in use in conjunction with a crossbeam attachment bracket. In FIGS. 3 and 4, a crossbeam that may support a shelf, drawer, or any other rack accessory is attached to the upright using a crossbeam attachment bracket with a substantially similar mechanism to the stacking bracket on the inner receiver attachment open aperture hole of the upright posts of the storage rack. A stacking bracket is then provided on the outer receiver attachment open aperture hole of the upright posts to secure the stacked upright along with the shelf attachment bracket. Of course, other accessories using similar attachment brackets may also be used in conjunction with the stacking bracket.

FIG. 5 shows a detailed view of a crossbeam or brace arrangement, featuring a horizontal crossbeam and diagonally-oriented crossbeam attached to a pair of upright posts with a crossbeam attachment mechanism, substantially similar to the stacking bracket mechanism, connected with the inner receiver attachment open aperture holes of the storage rack upright posts. Again, stacking brackets are provided and attached on the outer receiver open aperture holes of these upright posts to secure the stacked rack assembly upright posts.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

1. (canceled)

2. A stacking bracket comprising:
a first and second extension forming an L-shaped bracket structure; and
locking tabs formed in one of the first and second extensions, such that the bracket tabs may suitably engage with an open receiving slot in a shelving structural support post.

3. A stacking bracket rack assembly, comprising
a first and second extension forming an L-shaped bracket structure, with locking tabs formed in one of the first and second extensions;
an upright shelving structural support frame post with an open receiving hole slot, wherein the open receiving hole slot is wider toward the top and progressively narrows toward the bottom, such that the bracket structure locking tabs may suitably be inserted into the wider open receiving hole slot and attach at a narrower lower portion of the hole slot;
one or more shelves suitable for simultaneous fixed contact or attachment with a suitable bracket structure to retain a fixed height and horizontal orientation, and one or more crossbeam or brace structures suitable to retain the upright shelving support rack posts in a fixed spatial arrangement and orientation.

4. The stacking bracket rack assembly of claim 3, further comprising a solid locking pin, further wherein the L-shaped bracket structure further comprises an aperture suitable for placing a locking pin such that the pin may extend through both the bracket aperture and an open receiving hole slot of an upright shelving support frame post to promote secure attachment between the bracket and the upright shelving structure frame post.

5. The stacking bracket rack assembly of claim 3, further wherein one or more rack units comprising upright shelving support posts in fixed spatial arrangement and orientation may be vertically stacked and connected together by L-shaped bracket structures with locking tabs.

6. The stacking bracket rack assembly of claim 3, further wherein drawers, other structural components, or rack accessories may suitably be attached by mounting brackets.

7. A method for arranging a rack unit assembly unit as a stable shelving arrangement, comprising the steps of:
placing and arranging one or more bracket structures featuring first and second extensions forming an L-shape with locking tabs formed in one of the first and second extensions;
attaching each bracket structures to a suitable receiver upright shelving structural support post with an open receiving hole slot as part of a rack unit assembly, wherein the open receiver support hole slot is wider toward the top and progressively narrows toward the bottom, such that the bracket structure locking tabs may suitably be inserted into the wider portion of the open receiving hole slot and attach at a narrower lower portion of the receiving hole slot, further wherein the rack unit assembly features a group of upright shelving structural support posts and one or more shelves suitable for simultaneous fixed contact or attachment with bracket structures to the upright shelving structural support posts to retain a fixed height and horizontal orientation, and one or more cross member structures suitable to retain the upright shelving support posts in a fixed spatial arrangement and orientation to comprise a stable rack unit assembly.

8. The method of claim 7, further comprising use of one or more solid locking pins to secure the rack unit assembly as a stable shelving arrangement, further wherein one or more L-shaped bracket structures with locking tabs further comprise an aperture therein suitable for inserting a locking pin such that the pin may extend through both the bracket aperture and an open receiving hole slot of an upright shelving support post and thereby promote secure attachment between the bracket and the upright shelving structure post.

9. The method of claim 7, further comprising the step of vertically stacking and connecting together, via L-shaped bracket structures with locking tabs, one or more rack assembly units of upright shelving support posts in a stable spatial arrangement and orientation.
